(19) United States
(12) Patent Application Publication
(10) Pub. No.: US 2015/0089449 A1
(43) Pub. Date: Mar. 26, 2015

(54) ELECTRONIC DEVICE AND METHOD FOR UNLOCKING THE ELECTRONIC DEVICE

(71) Applicant: FIH (Hong Kong) Limited, Kowloon (HK)

(72) Inventor: WANG-HUNG YEH, New Taipei (TW)

(21) Appl. No.: 14/495,154

(22) Filed: Sep. 24, 2014

(30) Foreign Application Priority Data
Sep. 24, 2013 (TW) 102134197

(51) Int. Cl. G06F 3/0484; G06F 3/0481; G06F 3/0482; G06F 3/0488

(52) U.S. Cl. CPC G06F 3/04847; G06F 3/0488; G06F 3/04817; G06F 3/0482
USPC 715/825; 715/835

(57) ABSTRACT

A method for unlocking an electronic device displays an unlocking interface on a touch screen of the electronic device, and detects unlocking touch operations of unlocking the electronic device on the unlocking interface. Virtual icons triggered in a sequence by each of the unlocking touch operations are confirmed, and a password corresponding to each of the unlocking touch operations is recorded according to a preset identifier of each of the confirmed virtual icons. An unlocking password is generated according to the recorded code of each of the unlocking touch operations and a touch sequence of the unlocking touch operations. If the unlocking password matches a locking password prestored in a storage device, the electronic device is unlocked.

### CROSS-REFERENCE TO RELATED APPLICATIONS

This application claims priority to Taiwan Patent Application No. 102134197 filed on Sep. 24, 2013, the contents of which are incorporated by reference herein.

### FIELD

The subject matter of the present disclosure relates to the management of user interfaces of electronic devices, and particularly to an electronic device and a method for unlocking the electronic device.

### BACKGROUND

Most electronic devices with touch screens (for example, smart phones) may be locked and unlocked using a slide operation on the touch screen. However, the slide operation can easily be observed, and thus data security cannot be ensured.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of an electronic device including an unlocking system.

FIG. 2 is a block diagram of one embodiment of an unlocking system included in the electronic device in FIG. 1.

FIG. 3 is a diagrammatic view of one embodiment of setting the locking password on a touch screen of electronic device of FIG. 1.

FIG. 4 is a flowchart of one embodiment of a method for unlocking the electronic device of FIG. 1.

FIG. 5 is a flowchart of one embodiment of a method of presetting a locking password of the electronic device in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.”

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives.

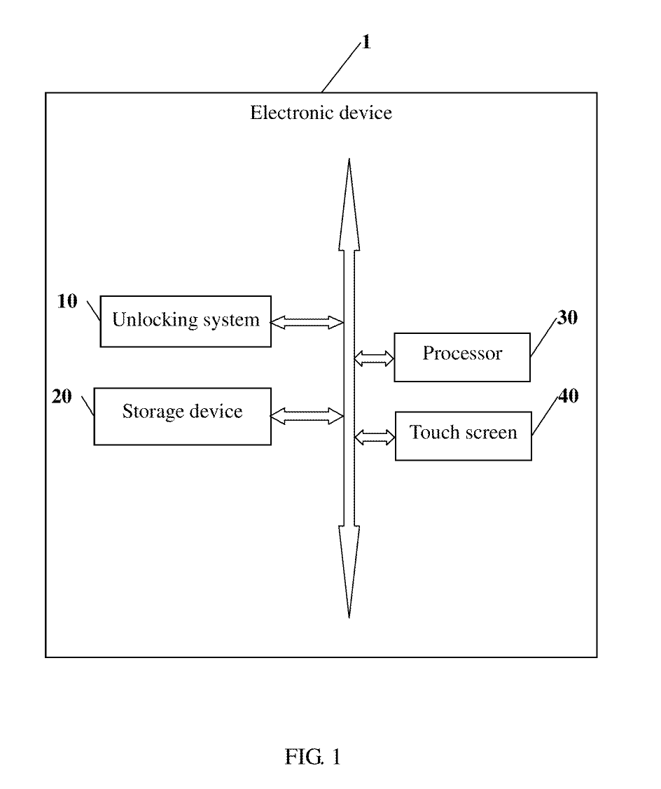

FIG. 1 is a block diagram of one embodiment of an electronic device including an unlocking system. In at least one embodiment, an electronic device 1 can be a mobile phone, a tablet computer, a notebook computer, or any other electronic device. The electronic device 1 includes, but is not limited to, an unlocking system 10, a storage device 20, at least one processor 30, and a touch screen 40. In at least one embodiment, the unlocking system 10 can preset a locking password according to touch operations, and unlock the electronic device 1 when an unlocking password generated by recognizing the touch operations matches the locking password.

The at least one processor 30 executes one or more computerized codes and other applications of the electronic device 1 to provide functions of the unlocking system 10. The storage device 20 can be a memory of the electronic device 1 or an external storage card, such as a smart media card or a secure digital card. The touch screen 40 can be a capacitive touch screen, a resistive touch screen or other types of touch screen supporting touch operations (including sliding operations) of a finger or a stylus, for example.

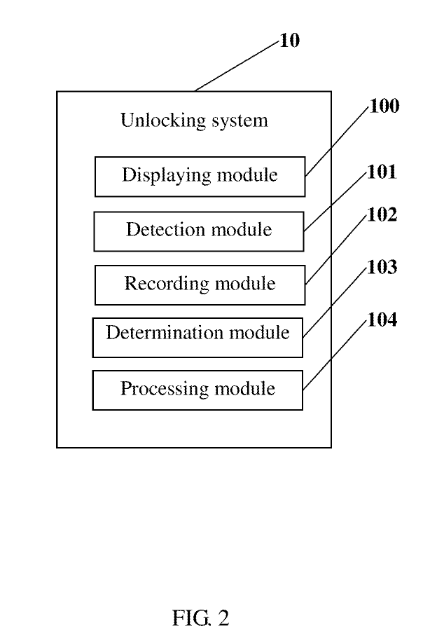

FIG. 2 is a block diagram of one embodiment of an unlocking system included in the electronic device in FIG. 1. In this embodiment, the unlocking system 10 can include a displaying module 100, a detection module 101, a recording module 102, a determination module 103, and a processing module 104. The modules 100-104 include computerized code in the form of one or more programs that are stored in the storage device 20. The computerized code includes instructions that are executed by the at least one processor 30 to provide functions of the unlocking system 10.

The display module 100 displays an unlocking interface on the touch screen 40 for a user to execute touch operations on the touch screen 40. When the electronic device 1 is required to preset a locking password, the user can execute touch operations of presetting the locking password (hereinafter referred to as “locking touch operations”) on the touch screen 40. When the electronic device 1 is required to be unlocked, the user can execute touch operations of an unlocking password (hereinafter referred to as “unlocking touch operations”) on the touch screen 40.

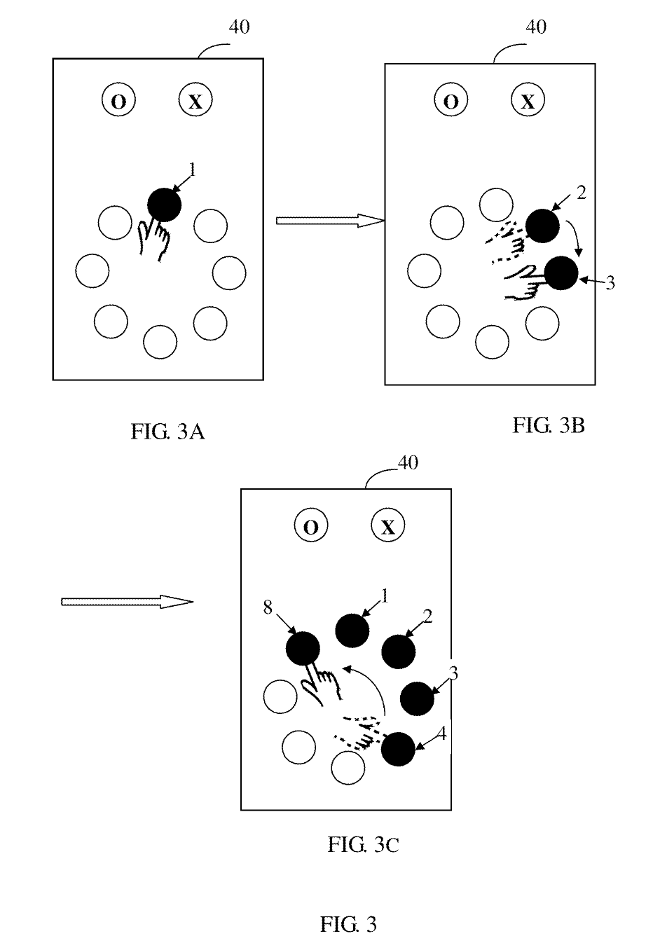

In at least one embodiment, the unlocking interface can include a plurality of virtual icons having preset shapes. For example, each of the virtual icons can be a shape of a sector, a ring, a sphere, a rectangle or any other types of shapes. FIG. 3 includes FIG. 3A, FIG. 3B, and FIG. 3C, which show diagrammatic views of one embodiment of setting a locking password on a touch screen of an electronic device. As shown in FIG. 3A, each of the virtual icons can be a round shape and the virtual icons can form a ring. The number of the virtual icons can be preset according to a user's preference.

In some embodiments, each of the virtual icons have a preset range on the touch screen 40 that can be indicated by coordinates, and each of the virtual icons can be displayed with a first status initially. When no touch point of the touch operation is detected on a preset range of one virtual icon, the virtual icon is displayed with a first status initially. When a user of the electronic device 1 executes a single touch operation (for example, a sliding operation) using a finger or other object (e.g., a stylus) on the touch screen 40, one or more virtual icons can be triggered by the single touch operation. In at least one embodiment, if coordinates of one touch point of the single touch operation on the touch screen 40 is within a preset range of a virtual icon, the virtual icon is determined to be triggered by the single touch operation. Similarly, if coordinates of more than one touch point of the single touch operation are within preset ranges of more than one virtual icons, the more than one virtual icons are determined to be triggered by the single touch operation. That is, one specified single touch operation can trigger one or more virtual icons by recognizing coordinates of touch points of the specified single touch operation.

After one or more virtual icons are determined to be triggered, the one or more virtual icons can be displayed with a second status. In at least one embodiment, once the finger or other object leaves the touch screen 40 and the touch operation is determined to be released (or finished), the second status of the triggered virtual icons can change to the first status. In at least one embodiment, the first status of the virtual icons can be a first color or a first color combination, and the second status of the virtual icons can be a second color or a second color combination. In other embodiments, the first status of the virtual icons can be a first shape, and the second status of the virtual icons can be a second shape. In at least one embodiment, each virtual icon can correspond to a preset identifier. When one or more virtual icons are triggered, a password corresponding to the triggered virtual icons can be determined according to a preset identifier of each of the triggered virtual icons.

The detection module 101 detects the locking/unlocking touch operations performed on the touch screen 40, and confirms triggered virtual icons in a sequence by each of the locking/unlocking touch operations. When the user uses a finger or other tool (e.g., a stylus) to slide on the touch screen 40, the detection module 101 can further change the triggered virtual icons from the first status to the second status, for prompting the password of the touch operation for the user. In at least one embodiment, the detection module 101 can confirm one virtual icon triggered by each of the locking/unlocking touch operations, and also can confirm a plurality of virtual icons triggered in a sequence by each of the locking/unlocking touch operations.

The recording module 102 records a code corresponding to each of the locking/unlocking touch operations according to a preset identifier of each of the confirmed virtual icons of each of the locking/unlocking touch operations. In at least one embodiment, when the locking touch operations are executed on the electronic device 1 to preset the locking password, the recording module 102 records the code corresponding to each of the locking touch operations in a first position of the storage device 20. When the unlocking touch operations are executed on the electronic device 1 to unlock the electronic device 1, the recording module 102 records the cord corresponding to each of the unlocking touch operations in a second position of the storage device 20 temporarily.

For example, FIG. 3A shows that one touch point of a first touch operation is within a preset range of a virtual icon labeled “1”. The virtual icon labeled “1” in FIG. 3A is triggered to change from white to black, and the recording module 102 can recorded a code of “[1]” corresponding to the first touch operation. FIG. 3B shows that at least two touch points of a second touch operation, which trigger two virtual icons labeled “2” and “3” in a sequence. The virtual icons labeled “2” and “3” in FIG. 3B are triggered to change from white to black, and the recording module 102 can recorded a code of “[2, 3]” corresponding to the second touch operation. FIG. 3C shows that at least five touch points of a third touch operation, which trigger five virtual icons labeled “4”, “3”, “2”, “1”, “8” in a sequence. The virtual icons labeled “4”, “3”, “2”, “1”, “8” in FIG. 3C are triggered to change from white to black, and the recording module 102 can recorded a code of “[4, 3, 2, 1, 8]” corresponding to the third touch operation.

During presetting the locking password, the determination module 103 determines whether the electronic device 1 receives a first command, and further determines whether the electronic device 1 receives a second command. In at least one embodiment, the first command is used to clear the recorded code corresponding to each of the locking touch operations, and the second command is used to confirm that the locking touch operations have been finished. In at least one embodiment, the unlocking interface can further include a first virtual button and a second virtual button. As shown in FIG. 3A, the first virtual button can be a virtual button marked with “X” and the second virtual button can be a virtual button marked with “O” in FIG. 3A. If the first virtual button is triggered, the electronic device 1 receives the first command. If the second virtual button is triggered, the electronic device 1 receives the second command.

If the electronic device 1 receives the first command, the processing module 104 clears the recorded code corresponding to each of the locking touch operations in the first position and prompts the user to execute the locking touch operations again. In at least one embodiment, the processing module 104 displays a prompt message on the touch screen 40 or output an audio prompt using a speaker of the electronic device 1.

If the electronic device 1 receives the second command, the processing module 104 generates the locking password by combining the recorded code corresponding to each of the locking touch operations according to a touch sequence of the locking touch operation, and stores the locking password in a preset position of the storage device 20.

During the electronic device 1 executes the unlocking touch operations, the processing module 104 generates the unlocking password by combining the recorded code corresponding to each of the unlocking touch operations according to a touch sequence of the unlocking touch operations when the unlocking touch operations for the unlocking password are determined to be finished. Based on the example shown in FIGS. 3A, 3B and 3C, an unlocking password can be “([1], [2, 3], [4, 3, 2, 1, 8])” by combining the recorded codes “[1]”, “[2, 3]”, and “[4, 3, 2, 1, 8]”. In one embodiment, the unlocking touch operations can be determined to be finished when no more touch operation is detected in a preset time duration (for example, 3 seconds). In other embodiment, the unlocking touch operations can be determined to be finished when a preset finished command is triggered.

The determination module 103 further determines whether the unlocking password matches the locking password. For example, the determination module 103 can compare each recorded code in the unlock password with a corresponding recorded code in the locking password respectively, for example, the first recorded code in the unlock password being compared with the first recorded code in the locking password, and the second recorded code in the unlock password being compared with the first recorded code, and so on. If each recorded code in the unlocking password is the same as the corresponding recorded code in the locking password, the determination module 103 determines that the unlocking password matches the locking password. If there is at least one recorded code in the unlocking password different from the corresponding recorded code in the locking password, the determination module 103 determines that the unlocking password does not match the locking password. In other embodiments, the determination module 103 can firstly determine whether a first number of the recorded codes in the unlocking password and a second number of the recorded codes in the locking password is the same. If the first number is equal to the second number, the determination module 103 then compares each recorded code in the unlock password with a corresponding recorded code in the locking password respectively. If the first number is not equal to the second number, the determination module 103 determines that the unlocking password does not match the locking password directly.

The processing module 104 unlocks the electronic device 1 when the unlocking password is determined to match the locking password.

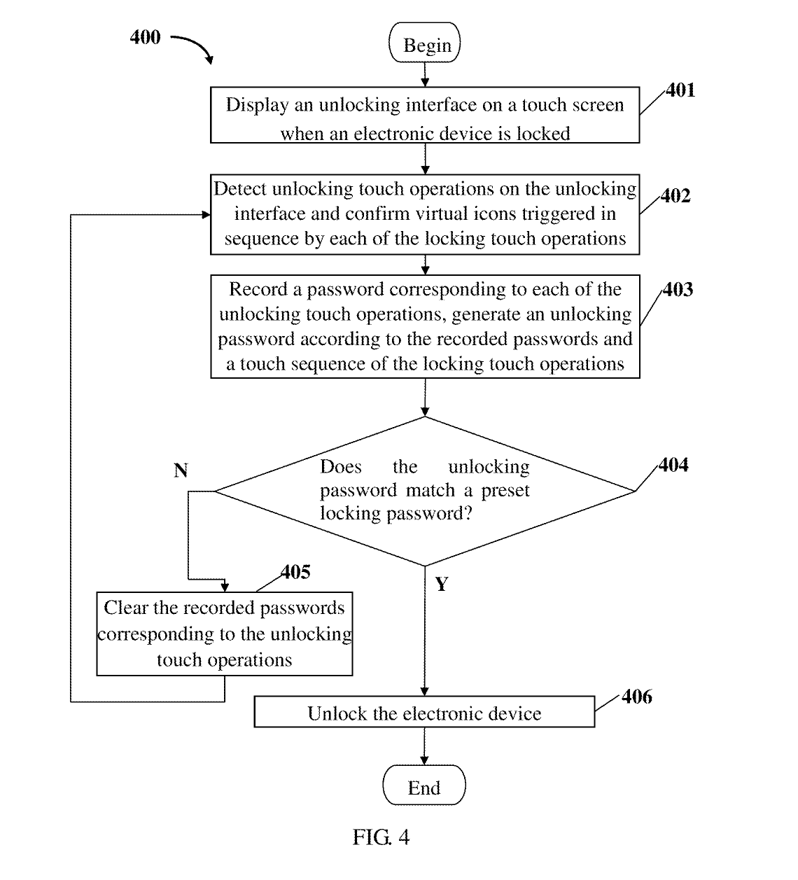

FIG. 4 is a flowchart of one embodiment of a method for unlocking the electronic device of FIG. 1. Depending on the embodiment, additional blocks can be added, others removed, and the ordering of the blocks can be changed. In the embodiment, the method 400 is performed by execution of computer-readable software program codes or instructions by at least one processor of a computing device. The method 400 is provided by way of example, as there are a variety of ways to carry out the method. The method 400 described below can be carried out using the configurations illustrated in FIG. 1-FIG. 2, for example, and various elements of these figures are referenced in explaining method 400. Each block shown in FIG. 4 represents one or more processes, methods or subroutines, carried out in the method 400. Additionally, the illustrated order of blocks is by example only and the order of the blocks can change according to the present disclosure. The example method 400 can begin at block 401.

In block 401, when the electronic device 1 requires to unlock the electronic device 1, the display module displays the unlocking interface on the touch screen 40 for users to execute the unlocking touch operations of unlocking the electronic device 1. In at least one embodiment, the unlocking interface can include a plurality of virtual icons having preset shapes. Each of the virtual icons are displayed with a first status initially.

In block 402, the detection module detects the unlocking touch operations on the touch screen 40, and confirms virtual icons triggered in a sequence by each of the unlocking touch operations. In at least one embodiment, when coordinates of one touch point of the touch operation on the touch screen 40 is within the preset range of one virtual icon, the virtual icon is determined to be triggered and the triggered virtual icons can be displayed with a second status.

In block 403, the recording module records a code corresponding to each of the unlocking touch operations according to a preset identifier of each of the confirmed virtual icons, and the processing module generates the unlocking password by combining the recorded code corresponding to each of the unlocking touch operations according to a touch sequence of the unlocking touch operations when the unlocking touch operation for the unlocking password is determined to be finished. In at least one embodiment, the recording module can record the code for the unlocking touch operations in a second position of the storage device 20.

In block 404, the determination module determines whether the unlocking password matches a preset locking password. The determination module can compare each recorded code in the unlock password with a corresponding recorded code in the locking password respectively, for example, the first recorded code in the unlock password being compared with the first recorded code in the locking password, and the second recorded code in the unlock password being compared with the first recorded code, and so on. When each recorded code in the unlocking password is the same as the corresponding recorded code in the locking password, the determination module determines that the unlocking password matches the locking password, and block 406 is implemented. When there is at least one recorded code in the unlocking password different from the corresponding recorded code in the locking password, the determination module determines that the unlocking password does not match the locking password, and block 405 is implemented.

In block 405, the processing module clears the recorded code corresponding to each of the unlocking touch operations in the second position and prompts the user to execute the unlocking touch operations for unlocking the electronic device 1 again, and block 402 is implemented.

In block 406, the processing module unlocks the electronic device 1, and the procedure ends.

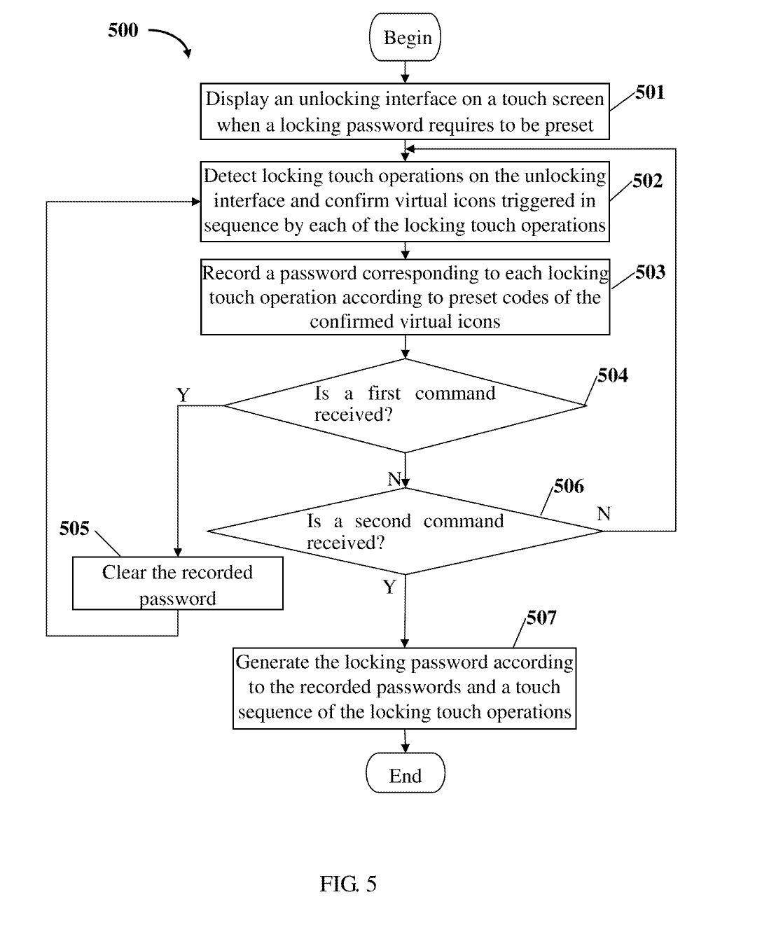

FIG. 5 is a flowchart of one embodiment of a method of presetting a locking password of the electronic device in FIG. 1. Depending on the embodiment, additional blocks can be added, others removed, and the ordering of the blocks can be changed. In the embodiment, the method 500 is performed by execution of computer-readable software program codes or instructions by at least one processor of a computing device. The method 500 is provided by way of example, as there are a variety of ways to carry out the method. The method 500 described below can be carried out using the configurations illustrated in FIG. 1-FIG. 2, for example, and various elements of these figures are referenced in explaining method 500. Each block shown in FIG. 5 represents one or more processes, methods or subroutines, carried out in the method 500. Additionally, the illustrated order of blocks is by example only and the order of the blocks can change according to the present disclosure. The example method 500 can begin at block 501.

In block 501, when the electronic device 1 requires to preset a locking password for locking the electronic device 1, the display module displays the unlocking interface on the touch screen 40 for a user to execute locking touch operations on the touch screen 40.

In block 502, the detection module detects the locking touch operation of the locking password on the touch screen 40, and confirms virtual icons triggered in a sequence by each of the lucking touch operations. In at least one embodiment, when coordinates of one touch point of the touch operation on the touch screen 40 is within the preset range of one virtual icon, the virtual icon is determined to be triggered and the triggered virtual icons can be changed from a first status to a second status.

In block 503, the recording module records a code corresponding to each of the locking touch operations according to a preset identifier of each of the confirmed virtual icons. In at least one embodiment, the recording module can record the code for the locking touch operations in a first position of the storage device 20.

In block 504, the determination module determines whether the electronic device 1 receives a first command. In at least one embodiment, if a first virtual button in the unlocking interface is triggered, the determination module determines that the electronic device receives the first command. If the determination module determines that the electronic device 1 receives the first command, block 505 is implemented. If the determination module determines that the electronic device 1 does not receive the first command, block 506 is implemented.

In block 505, the processing module clears the recorded code corresponding to each of the locking touch operations in the first position and prompts the user to execute the locking touch operations of setting the locking password again, and block 502 is implemented.

In block 506, the determination module determines whether the electronic device 1 receives a second command. In one embodiment, if a second virtual button in the unlocking interface is triggered, the determination module determines that the electronic device receives the second command. If the determination module determines that the electronic device 1 receives the second command, block 507 is implemented. If the determination module determines that the electronic device 1 does not receive the second command, block 502 is implemented to receive a next locking touch operation.

In block 507, the processing module generates the locking password by combining the recorded code corresponding to each of the locking touch operations according to a touch sequence of the locking touch operations, and stores the locking password in a preset position of the storage device 20.

All of the processes described above may be embodied in, and fully automated via, functional code modules executed by one or more general purpose processors such as the processor 30. The code modules may be stored in any type of non-transitory readable medium or other storage device such as the storage device 20. Some or all of the methods may alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications may be made without departing substantially from the scope of the present disclosure. All such modifications and variations are intended to be included within the scope of this disclosure and the described inventive embodiments, and the present disclosure is protected by the following claims and their equivalents.

What is claimed is:

1. A computer-implemented method for unlocking an electronic device, the method comprising:
displaying an unlocking interface on a touch screen of the electronic device, the unlocking interface comprising a plurality of virtual icons;
detecting unlocking touch operations on the unlocking interface;
confirming virtual icons triggered in a sequence by each of the unlocking touch operations;
recording a code corresponding to each of the unlocking touch operations according to a preset identifier of each of the confirmed virtual icons;
generating an unlocking password according to the recorded code of each of the unlocking touch operations and a touch sequence of the unlocking touch operations; and
unlocking the electronic device when the unlocking password matches a locking password prestored in a storage device of the electronic device.

2. The method according to claim 1, wherein the locking password is prestored by:
displaying the unlocking interface on the touch screen when the electronic device starts to preset the locking password;
detecting locking touch operations of presetting the locking password;
confirming virtual icons triggered in a sequence by each of the locking touch operations;
recording a code corresponding to each of the locking touch operations according to a preset identifier of each of the confirmed virtual icons;
determining whether the electronic device receives a first command;
clearing the recorded code corresponding to each of the locking touch operations when the electronic device receives the first command, and returning to the step of detecting the locking touch operations of presetting the locking password;
determining whether the electronic device receives a second command when the electronic device does not receive the first command; and
generating a locking password according to the recorded code of each of the unlocking touch operations and a touch sequence of the locking touch operations when the electronic device receives the second command, and storing the locking password in the storage device.

3. The method according to claim 2, wherein the unlocking interface comprises a first virtual button to trigger the first command and a second virtual button to trigger the second command.

4. The method according to claim 2, wherein the plurality of virtual icons on the unlocking interface are displayed with a first status initially, and the virtual icons are determined to be triggered when coordinates of one touch point of each of the locking or unlocking touch operations is within preset ranges of the virtual icons, and the virtual icons are changed to be displayed with a second status after triggering.

5. The method according to claim 4, wherein the first status of the virtual icons comprise a first color, a first color combination, and/or a first shape, and the second status of the virtual icons comprise a second color, a second color combination, and/or a second shape.

6. The method according to claim 1, further comprising:
clearing the recorded code in the storage device and prompting the user to execute the locking touch operations again for presetting the locking password, when the locking password does not match the unlocking password.

7. A non-transitory storage medium storing a set of instructions, when executed by at least one processor of an electronic device, cause the at least one processor to perform a method for unlocking the electronic device, the method comprising:
displaying an unlocking interface on a touch screen of the electronic device, the unlocking interface comprising a plurality of virtual icons;
detecting unlocking touch operations on the unlocking interface;
confirming virtual icons triggered in a sequence by each of the unlocking touch operations;
recording a code corresponding to each of the unlocking touch operations according to a preset identifier of each of the confirmed virtual icons;
generating an unlocking password according to the recorded code of each of the unlocking touch operations and a touch sequence of the unlocking touch operations; and
unlocking the electronic device when the unlocking password matches a locking password prestored in a storage device of the electronic device.

8. The storage medium according to claim 7, wherein the locking password is prestored by:
displaying the unlocking interface on the touch screen when the electronic device starts to preset the locking password;
detecting locking touch operations of presetting the locking password;
confirming virtual icons triggered in a sequence by each of the locking touch operations;
recording a code corresponding to each of the locking touch operations according to a preset identifier of each of the confirmed virtual icons;
determining whether the electronic device receives a first command;
clearing the recorded code corresponding to each of the locking touch operations when the electronic device receives the first command, and returning to the step of detecting the locking touch operations of presetting the locking password;
determining whether the electronic device receives a second command when the electronic device does not receive the first command; and
generating a locking password according to the recorded code of each of the unlocking touch operations and a touch sequence of the locking touch operations when the electronic device receives the second command, and storing the locking password in the storage device.

9. The storage medium according to claim 8, wherein the unlocking interface comprises a first virtual button to trigger the first command and a second virtual button to trigger the second command.

10. The storage medium according to claim 8, wherein the plurality of virtual icons on the unlocking interface are displayed with a first status initially, and the virtual icons are determined to be triggered when coordinates of one touch point of each of the locking or unlocking touch operations is within preset ranges of the virtual icons, and the virtual icons are changed to be displayed with a second status after triggering.

11. The storage medium according to claim 10, wherein the first status of the virtual icons comprise a first color, a first color combination, and/or a first shape, and the second status of the virtual icons comprise a second color, a second color combination, and/or a second shape.

12. The storage medium according to claim 7, the method further comprises:
clearing the recorded code in the storage device and prompting the user to execute the locking touch operations again for presetting the locking password, when the locking password does not match the unlocking password.

13. An electronic device comprising:
a touch screen;
at least one processor; and
a storage device storing one or more programs, which when executed by the at least one processor, cause the at least one processor to:
display an unlocking interface on a touch screen of the electronic device, the unlocking interface comprising a plurality of virtual icons;
detect unlocking touch operations on the unlocking interface;
confirm virtual icons triggered in a sequence by each of the unlocking touch operations;
recorded a code corresponding to each of the unlocking touch operations according to a preset identifier of each of the confirmed virtual icons;
generate an unlocking password according to the recorded code of each of the unlocking touch operations and a touch sequence of the unlocking touch operations; and
unlock the electronic device when the unlocking password matches a locking password prestored in a storage device of the electronic device.

14. The electronic device according to claim 13, wherein the locking password is prestored by:
displaying the unlocking interface on the touch screen when the electronic device starts to preset the locking password;
detecting locking touch operations of presetting the locking password;
confirming virtual icons triggered in a sequence by each of the locking touch operations;
recording a code corresponding to each of the locking touch operations according to a preset identifier of each of the confirmed virtual icons;
determining whether the electronic device receives a first command;
clearing the recorded code corresponding to each of the locking touch operations when the electronic device receives the first command, and returning to the step of detecting the locking touch operations of presetting the locking password;
determining whether the electronic device receives a second command when the electronic device does not receive the first command; and
generating a locking password according to the recorded code of each of the unlocking touch operations and a touch sequence of the locking touch operations when the electronic device receives the second command, and storing the locking password in the storage device.

15. The electronic device according to claim 14, wherein the unlocking interface comprises a first virtual button to trigger the first command and a second virtual button to trigger the second command.

16. The electronic device according to claim 14, wherein the plurality of virtual icons on the unlocking interface are displayed with a first status initially, and the virtual icons are determined to be triggered when coordinates of one touch point of each of the locking or unlocking touch operations is within preset ranges of the virtual icons, and the virtual icons are changed to be displayed with a second status after triggering.

17. The electronic device according to claim 16, wherein the first status of the virtual icons comprise a first color, a first color combination, and/or a first shape, and the second status of the virtual icons comprise a second color, a second color combination, and/or a second shape.

18. The electronic device according to claim 13, wherein the at least one processer further clears the recorded code in the storage device and prompting the user to execute the locking touch operations again for presetting the locking password, when the locking password does not match the unlocking password.
